(19) United States
(12) Patent Application Publication
(10) Pub. No.: US 2026/0081810 A1
(43) Pub. Date: Mar. 19, 2026

(54) DATA ENCODING WITHOUT OVERHEAD

(71) Applicant: KONINKLIJKE PHILIPS N.V., EINDHOVEN (NL)

(72) Inventors: Jeffrey Daniel Sherman, Cambridge, MA (US); Bernard Joseph Savord, Andover, MA (US)

(21) Appl. No.: 19/105,538

(22) PCT Filed: Aug. 22, 2023
(86) PCT No.: PCT/EP2023/072969

§ 371 Date: Feb. 21, 2025

Related U.S. Application Data
(60) Provisional application No. 63/401,442, filed on Aug. 26, 2022.

(51) Int. Cl. H04L 25/03; G06F 5/08; H04L 27/26

(52) U.S. Cl. CPC H04L 25/03866; G06F 5/08; H04L 27/2656

(57) ABSTRACT

A method of encoding data for transmission includes aligning and tagging a start of a data stream; receiving, at a communication interface comprising a scrambler (111C1), a digitized signal comprising formatted digital data; scrambling the formatted digital data into scrambled digital data to reduce spectral bandwidth and enhance balance between amounts of digit values of the digital data and without adding coding bits to the formatted digital data; and outputting the scrambled digital data.

### BACKGROUND

In digital communication circuits, DC balance refers to balance between the number of digits in a signal. In digital communication circuits, ensuring an equal number of 1's and 0's being transmitted improves signal fidelity by reducing low frequency content transmitted, thus making systems with digital communications circuits more robust against low frequency noise. Clock recovery circuits require a certain number of transitions per string of bits (run length) to guarantee a stable clock. The 8b/10b encoding scheme guarantees DC balance and short run lengths by mapping the 8 bit input word into a 10 bit code, running an extra 25% data overhead and data processing. Other encoding schemes, such as 64b/66b or 128b/132b encoding, offer smaller overheads and also rely on scrambling methods to “statistically” guarantee DC balance, with run lengths guaranteed by the overhead bits.

### SUMMARY

According to an aspect of the present disclosure, a method of encoding data for transmission includes aligning and tagging a start of a data stream; receiving, at a communication interface comprising a scrambler, a digitized signal comprising formatted digital data; scrambling the formatted digital data into scrambled digital data to reduce spectral bandwidth and enhance balance between amounts of digit values of the digital data and without adding coding bits to the formatted digital data; and outputting the scrambled digital data.

According to another aspect of the present disclosure, a digital interface includes a receiver, a scrambler, and an output. The receiver receives a digitized signal comprising formatted digital data, the receiver comprising a receive logic device adapted to detect an alignment code and align with respect to this code. The scrambler scrambles the formatted digital data into scrambled digital data to reduce spectral bandwidth and enhance balance between amounts of digit values of the digital data and without adding coding bits to the formatted digital data. The output outputs the scrambled digital data. In a data flow between an ultrasound transducer and a processing system, the reduction in overhead coding bits results in reduced data rates and processing loads and improved overall efficiency.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A illustrates a system for data encoding without overhead, in accordance with a representative embodiment.

FIG. 1B illustrates another system for data encoding without overhead, in accordance with a representative embodiment.

FIG. 1C illustrates another system for data encoding without overhead, in accordance with a representative embodiment.

FIG. 1D illustrates another system for data encoding without overhead, in accordance with a representative embodiment.

FIG. 2A illustrates a digital interface for data encoding without overhead, in accordance with a representative embodiment.

FIG. 2B illustrates a timing relationship for data encoding without overhead, in accordance with a representative embodiment.

FIG. 3A illustrates a method for data encoding without overhead, in accordance with a representative embodiment.

FIG. 3B illustrates another method for data encoding without overhead, in accordance with a representative embodiment.

FIG. 4 illustrates an example circuit of a scrambler for data encoding without overhead, in accordance with a representative embodiment.

FIG. 5 illustrates a computer system, on which a method for data encoding without overhead is implemented, in accordance with another representative embodiment.

### DETAILED DESCRIPTION

In the following detailed description, for the purposes of explanation and not limitation, representative embodiments disclosing specific details are set forth in order to provide a thorough understanding of embodiments according to the present teachings. However, other embodiments consistent with the present disclosure that depart from specific details disclosed herein remain within the scope of the appended claims. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. Definitions and explanations for terms herein are in addition to the technical and scientific meanings of the terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

As used in the specification and appended claims, the singular forms of terms ‘a’, ‘an’ and ‘the’ are intended to include both singular and plural forms, unless the context clearly dictates otherwise. Additionally, the terms “comprises”, and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to”, “coupled to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

The present disclosure, through one or more of its various aspects, embodiments and/or specific features or sub-components, is thus intended to bring out one or more of the advantages as specifically noted below.

As described herein, a scrambler is used to modulate a digitized signal before transmitting the data to reduce its low-frequency spectral bandwidth and improve the signal-to-noise ratio. A digital interface that includes the scrambler may eliminate the use of coding bits to improve power efficiency in the transmission, and may rely on statistical properties to meet run length and DC balance requirements. The digital interface may reduce the necessary power in, for example, a digital transducer probe in an ultrasound system by using a reconfigurable parallel scrambler topology. The digital interface may be used in any digital transducer probe to ensure a robust signal integrity, though teachings herein are not limited to digital transducer probes.

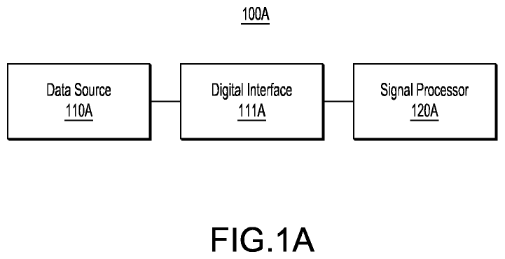

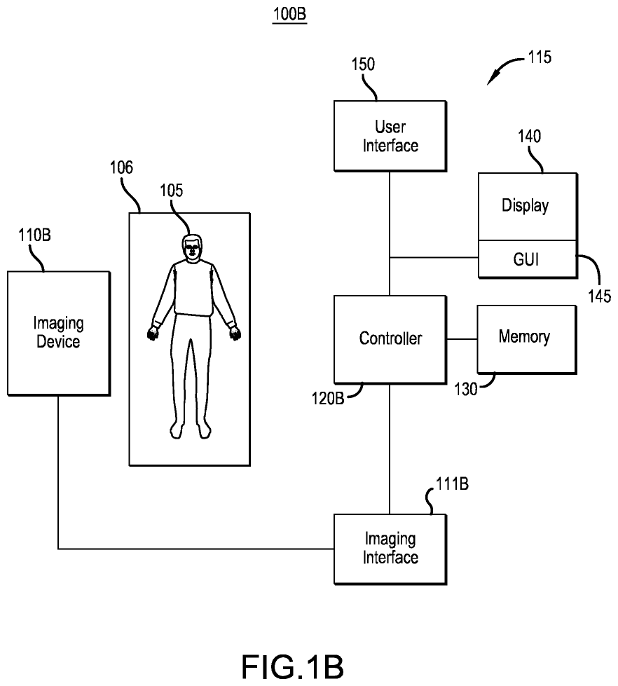

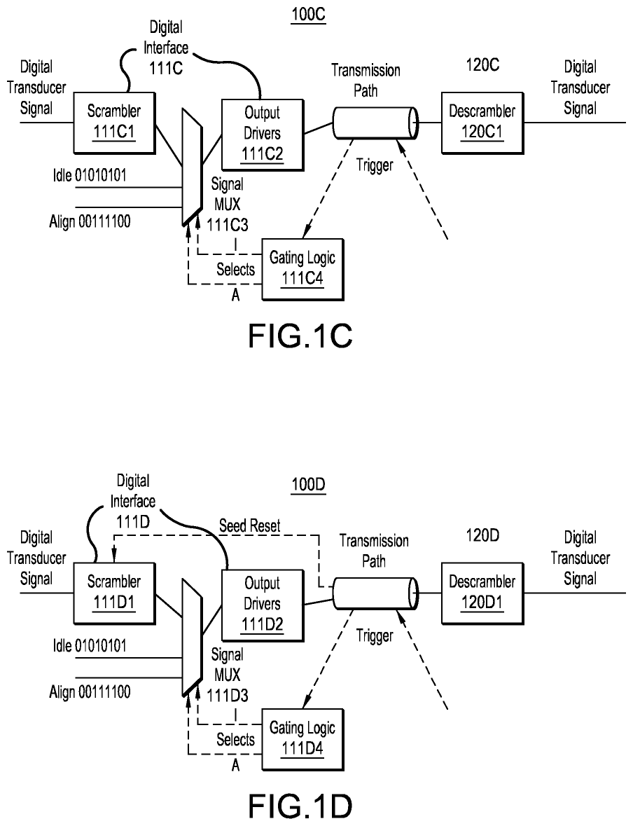

FIG. 1A illustrates a system for data encoding without overhead, in accordance with a representative embodiment.

The system 100A in FIG. 1A includes a data source 110A, a digital interface 111A and a signal processor 120A. The data source 110A may be any of a variety of data sources such as a medical imaging device or networked security camera. The digital interface 111A may comprise a circuit including a scrambler as described more below. The signal processor 120A may receive and process signals from the digital interface 111A. The data source 110A, the digital interface 111A and the signal processor 120A may be connected by wires and/or by wireless signals, and each may include circuit elements such as transmitters, receivers, memories, processors and interfaces for inputting and outputting data and instructions.

The digital interface 111A is configured to implement a method of encoding data for transmission. The method may include aligning and tagging a start of a data stream generated based on the data from the data source 110A. The method may also include receiving a digitized signal comprising formatted digital data in the data stream generated based on the data from the data source 110A. The method performed by the digital interface 111A may also include scrambling the formatted digital data into scrambled digital data to reduce spectral bandwidth and enhance balance between amounts of digit values of the digital data and without adding coding bits to the formatted digital data. The method performed by the digital interface 111A also includes outputting the scrambled digital data to the signal processor 120A either directly via, for example, a wire, or indirectly via, for example a wireless network.

FIG. 1B illustrates another system for data encoding without overhead, in accordance with a representative embodiment.

The ultrasound imaging system 100B in FIG. 1B includes an imaging device 110B and a computer system 115 for controlling imaging of a region of interest, such as in a patient 105 on a table 106. The imaging device 110B is illustratively an ultrasound imaging system capable of providing an ultrasound (US) image scan of a region of interest in the patient 105. Illustratively, the imaging device 110B may be of a type commonly used in ultrasound imaging procedures.

The imaging device 110B may be adapted to provide color Doppler imaging or three dimensional flow volumetry imaging or continuous wave (CW) Doppler measurements. The imaging device 110B may illustratively comprise a transducer array that may include capacitive micromachined ultrasonic transducers (CMUTs) or piezoelectric transducers formed of materials such as PZT or PVDF, for example. The transducer array may be coupled to a micro-beamformer (not shown) in the imaging device, and controls reception of signals by the transducers. The imaging device 110B in FIG. 1B is an example of a data source 110A in FIG. 1A.

In some embodiments, the imaging device 110B may include features consistent with descriptions in commonly owned International Patent Application Publication No. WO2022069264, with an international filing date of Apr. 7, 2022, and U.S. Provisional Application No. 63/084,728, filed on Sep. 29, 2020. The entire disclosures of International Patent Application Publication No. WO2022069264 and U.S. Provisional Application No. 63/084,728 are specifically incorporated herein by reference (copies of these documents are attached to this filing).

The computer system 115 receives image data from the imaging device 110B, and stores and processes the imaging data according to representative embodiments described herein. The computer system 115 comprises a controller 120B, a memory 130, a display 140 which may optionally comprise a graphical user interface 145 (GUI), and a user interface 150. The display 140 may also include a loudspeaker (not shown) to provide audible feedback.

The controller 120B interfaces with the imaging device 110B through an imaging interface 111B. The imaging interface 111B may include a digital transducer interface (DTI) (not shown in FIG. 1B) and enables the connection and operation at comparatively high data rate transmission of digital data to and from a variety of imaging devices 110B contemplated for use in the ultrasound imaging system 100B. A DTI may comprise a plurality of ports and may enable operation of a selected one of multiple imaging devices 110B operating at comparatively high data rates in the ultrasound imaging system 100B. A DTI of the imaging interface 111B may enable switching at high data speed between the multiple imaging devices 110B, as well as receiving high data rate echo imaging data for further digital signal processing. In one aspect, the imaging interface 111B enables the implementation of a variety of imaging devices 110B employing multiple digital technologies requiring different voltages. Moreover, a DTI of the imaging interface 111B may enable compensation for voltage drops in cables connecting the imaging device 110B between the computer system 115 and the imaging device 110B. Furthermore, a DTI of the imaging interface 111B may enable operation of an imaging device 110B adapted to perform CW Doppler imaging, in addition to the imaging device 110B.

The imaging interface 111B is configured to implement a method of encoding data for transmission. The method may include aligning and tagging a start of a data stream generated based on the data from the imaging device 110B. The method may also include receiving a digitized signal comprising formatted digital data in the data stream generated based on the data from the imaging device 110B. The method performed by the imaging interface 111B may also include scrambling the formatted digital data into scrambled digital data to reduce spectral bandwidth and enhance balance between amounts of digit values of the digital data and without adding coding bits to the formatted digital data. The method performed by the imaging interface 111B also includes outputting the scrambled digital data to the controller 120B either directly via, for example, a wire, or indirectly via, for example a wireless network. The formatted digital data received by the imaging interface 111B may comprise an ultrasound signal. Scrambling at the imaging interface 111B may be based on statistical properties to meet run length requirements. The imaging interface 111B in FIG. 1B is an example of the digital interface 111A in FIG. 1A.

The memory 130 stores instructions executable by the controller 120B. When executed, and as described more fully below, the instructions cause the controller 120B to allow the user to perform different steps using the graphical user interface 145 or the user interface 150, or both, and, among other tasks, to initialize an ultrasound imaging device comprising a transducer. In addition, the controller 120B may implement additional operations based on executing instructions, such as instructing or otherwise communicating with another element of the computer system 115, including the memory 130 and the display 140, to perform one or more of the above-noted processes.

The controller 120B is representative of one or more processing devices, and is configured to execute software instructions stored in memory 130 to perform functions as described in the various embodiments herein. The controller 120B may be implemented by field programmable gate arrays (FPGAs), application specific integrated circuits (ASICs), systems on a chip (SOC), a general purpose computer, a central processing unit, a computer processor, a microprocessor, a graphics processing unit (GPU), a microcontroller, a state machine, programmable logic device, or combinations thereof, using any combination of hardware, software, firmware, hard-wired logic circuits, or combinations thereof. Additionally, any processing unit or processor herein may include multiple processors, parallel processors, or both. Multiple processors may be included in, or coupled to, a single device or multiple devices.

The term “processor” as used herein encompasses an electronic component configured to and able to execute a program or machine executable instruction. References to a computing device comprising “a processor” should be interpreted to include more than one processor or processing core, as in a multi-core processor. A processor may also refer to a collection of processors within a single computer system or distributed among multiple computer systems, such as in a cloud-based or other multi-site application. The term computing device should also be interpreted to include a collection or network of computing devices each including a processor or processors. Programs have software instructions performed by one or multiple processors that may be within the same computing device or which may be distributed across multiple computing devices.

The memory 130 may include a main memory and/or a static memory, where such memories may communicate with each other and the controller 120B via one or more buses. The memory 130 stores instructions used to implement some or all aspects of methods and processes described herein. The memory 130 may be implemented by any number, type and combination of random access memory (RAM) and read-only memory (ROM), for example, and may store various types of information, such as software algorithms, which serves as instructions, which when executed by a processor cause the processor to perform various steps and methods according to the present teachings. Furthermore, updates to the methods and processes described herein may also be provided to the computer system 115 and stored in memory 130.

The various types of ROM and RAM may include any number, type and combination of computer readable storage media, such as a disk drive, flash memory, an electrically programmable read-only memory (EPROM), an electrically erasable and programmable read only memory (EEPROM), registers, a hard disk, a removable disk, tape, compact disk read only memory (CD-ROM), digital versatile disk (DVD), floppy disk, Blu-ray disk, a universal serial bus (USB) drive, or any other form of storage medium known in the art. The memory 130 is a tangible storage medium for storing data and executable software instructions, and is non-transitory during the time software instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The memory 130 may store software instructions and/or computer readable code that enable performance of various functions. The memory 130 may be secure and/or encrypted, or unsecure and/or unencrypted.

“Memory” is an example of computer-readable storage media, and should be interpreted as possibly being multiple memories or databases. The memory or database for instance may be multiple memories or databases local to the computer, and/or distributed amongst multiple computer systems or computing devices. A computer readable storage medium is defined to be any medium that constitutes patentable subject matter under 35 U.S.C. § 101 and excludes any medium that does not constitute patentable subject matter under 35 U.S.C. § 101. Examples of such media include non-transitory media such as computer memory devices that store information in a format that is readable by a computer or data processing system. More specific examples of non-transitory media include computer disks and non-volatile memories.

The user interface 150 may include a user and/or network interface for providing information and data output by the controller 120B and/or the memory 130 to the user and/or for receiving information and data input by the user. That is, the user interface 150 enables the user to operate the imaging device as described herein, and to schedule, control or manipulate aspects of the ultrasound imaging system 100B of the present teachings. Notably, the user interface 150 enables the controller 120B to indicate the effects of the user's control or manipulation. The user interface 150 may include one or more of ports, disk drives, wireless antennas, or other types of receiver circuitry. The user interface 150 may further connect one or more interface devices, such as a mouse, a keyboard, a mouse, a trackball, a joystick, a microphone, a video camera, a touchpad, a touchscreen, voice or gesture recognition captured by a microphone or video camera, for example.

The display 140 may be a monitor such as a computer monitor, a television, a liquid crystal display (LCD), a light emitting diode (LED) display, a flat panel display, a solid-state display, or a cathode ray tube (CRT) display, or an electronic whiteboard, for example. The display 140 may also provide a graphical user interface 145 (GUI) for displaying and receiving information to and from the user.

FIG. 1C illustrates another system for data encoding without overhead, in accordance with a representative embodiment.

The system 100C in FIG. 1C includes a digital interface 111C and a processing system 120C. The digital interface 111C includes a scrambler 111C1, output drivers 111C2, a signal multiplexer 111C3 and gating logic 111C4. The scrambler 111C1 scrambles a digital transducer signal received at the digital interface 111C. The signal multiplexer 111C3 is configured to multiplex the scrambled digital transducer signal with or based on one or more other received signals such as the selected idle code or the selected align code. The output drivers 111C2 output the multiplexed signals over a transmission path to the processing system 120C. The gating logic 111C4 received a trigger from the processing system 120C and outputs a gate select signal I and an align select signal A to gate the Idle signal or the Align signal input to the signal multiplexer 111C3. The descrambler 120C1 descrambles the received multiplex signals and produces/reproduces the digital transducer signal.

The system 100C may be viewed as a block diagram of an arbitrary system configured to perform the teachings herein. The system 100C may be configured to scramble formatted data without headers, and is used to reduce the transmitted spectrum and save power. In FIG. 1C, the system 100C may perform self-synchronous scrambling, using the data of the digital transducer signal as a seed, so that only a polynomial is required to descramble the received multiplex signals by the descrambler 120C1. In other words, the system 100C may scramble and descramble a signal without, for example, frame synchronization. An alignment code is used to gate the time when valid data appears.

The digital interface 111C is configured to implement a method of encoding data for transmission. The method may include aligning and tagging a start of a data stream generated based on the digital transducer signal. The method may also include receiving a digitized signal comprising the digital transducer signal as formatted digital data. The method performed by the digital interface 111C may also include the scrambler 111C1 scrambling the formatted digital data into scrambled digital data to reduce spectral bandwidth and enhance balance between amounts of digit values of the digital data and without adding coding bits to the formatted digital data. The method performed by the digital interface 111C also includes outputting the scrambled digital data by the output drivers 111C2 to the processing system 120C either directly via, for example, a wire as the transmission path, or indirectly via, for example a wireless network as the transmission path.

FIG. 1D illustrates another system for data encoding without overhead, in accordance with a representative embodiment.

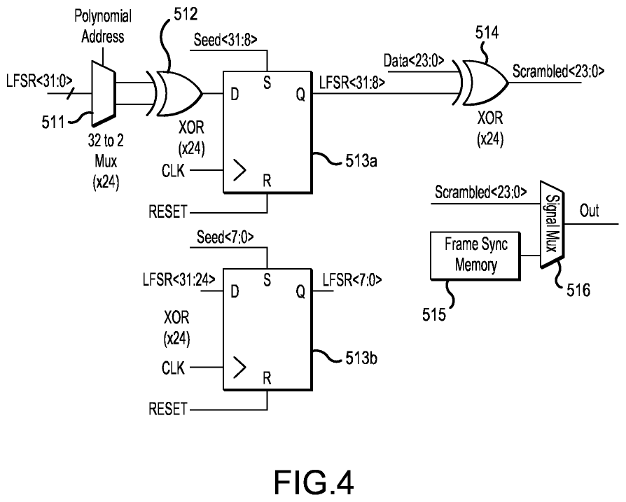

The system 100D in FIG. 1D includes a digital interface 111D and a processing system 120D. The digital interface 111D includes a scrambler 111D1, output drivers 111D2, a signal multiplexer 111D3 and a gating logic 111D4. The scrambler 111D1 scrambles a digital transducer signal received at the digital interface 111D. 111D1 and in the processing system 120D. The signal multiplexer 111D3 is configured to multiplex the scrambled digital transducer signal with or based on one or more other received signals such as the selected idle code or the selected align code. The output drivers 111D2 output the multiplexed signals over a transmission path to the processing system 120D. The gating logic 111D4 received a trigger from the processing system 120D and outputs a gate select signal I and an align select signal A to gate the Idle signal or the Align signal input to the signal multiplexer 111D3. In FIG. 4, the trigger signal from the processing system 120D also triggers a seed reset input to the scrambler 111D1 to reset the scrambler 111D1 to the starting seed value. The alignment code can be used to synchronize the descrambler 120D1 and gate the timing, and the seed reset is used to synchronize the scrambler 111D1. The descrambler 120D1 descrambles the received multiplex signals and produces/reproduces the digital transducer signal.

The system 100D may be viewed as a block diagram of an arbitrary system configured to perform the teachings herein. The system 100D may be configured to scramble formatted data without headers, and is used to reduce the transmitted spectrum and save power. In FIG. 1D, the system 100D may perform synchronous scrambling, using the seed reset to synchronize the seed code in the scrambler and using the alignment code to synchronize the descrambler and gate the timing.

The digital interface 111D is configured to implement a method of encoding data for transmission. The method may include aligning and tagging a start of a data stream generated based on the digital transducer signal. The method may also include receiving a digitized signal comprising the digital transducer signal as formatted digital data. The method performed by the digital interface 111D may also include the scrambler 111D1 scrambling the formatted digital data into scrambled digital data to reduce spectral bandwidth and enhance balance between amounts of digit values of the digital data and without adding coding bits to the formatted digital data. The method performed by the digital interface 111D also includes outputting the scrambled digital data by the output drivers 111D2 to the processing system 120D either directly via, for example, a wire as the transmission path, or indirectly via, for example a wireless network as the transmission path.

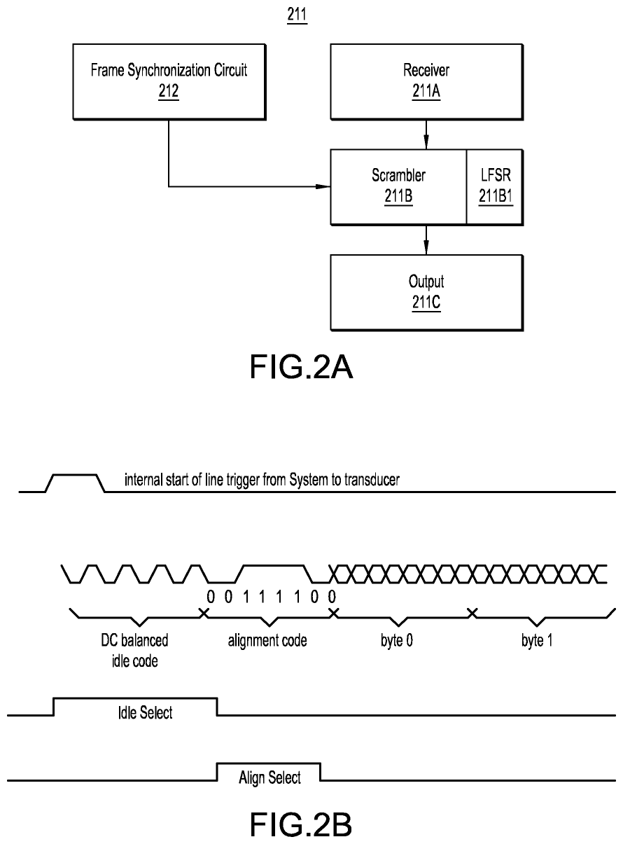

FIG. 2A illustrates a digital interface for data encoding without overhead, in accordance with a representative embodiment.

The digital interface 211 includes a frame synchronization circuit 212, a receiver 211A, a scrambler 211B with a LFSR 211B1 (linear feedback shift register), and an output 211C. The receiver 211A is configured to receive a digitized signal comprising formatted digital data. In embodiments based on a modification to FIG. 2A, the receiver 211A is configured to gate an alignment detection to search for the alignment code at a specific time interval. The frame synchronization circuit 212 synchronizes the seed code of the scrambler 211B and in the counterpart descrambler. The frame synchronization circuit 212 may perform one or more functions including transmitting a frame synchronization signal at a defined interval to synchronize a seed code and achieve bit alignment.

The digital interface 211 is configured to implement a method of encoding data for transmission. The method may include aligning and tagging a start of a data stream generated based on the digital transducer signal. The method may also include receiving a digitized signal comprising the digital transducer signal as formatted digital data. The method performed by the digital interface 211 may also include the scrambler 211B scrambling the formatted digital data into scrambled digital data to reduce spectral bandwidth and enhance balance between amounts of digit values of the digital data and without adding coding bits to the formatted digital data. The method performed by the digital interface 211 also includes outputting the scrambled digital data by the output 211C either directly via, for example, a wire, or indirectly via, for example a wireless network.

A digital interface 211 may be implemented in a digital transducer ultrasound system to remove bit overheads, save power, reduce the data rate, and simplify the system architecture. For example, the digital interface 211 may eliminate the 25% (2 bit) overhead of encoding schemes such as 8b/10b and the lesser, though still significant, overhead of encoding schemes such as 64b/66b coding schemes or 128b/132b coding schemes. The 64b/66b and 128b/132b coding schemes rely on a pseudorandom number generator to meet DC balance tolerance and use the extra bit overheads to guarantee run lengths and classify data types. The digital interface 211 and other digital interfaces described herein may be simplified to remove the bit overheads, save power, reduce the data rate, and simplify the system architecture. The scrambler 211B in FIG. 2A and other scramblers described herein may be implemented the LFSR 211B1, wherein the encoding scheme dictates which polynomial is used in the LFSR 211B1. The scrambler 211B may, however, be reconfigurable to allow a user to dictate the scrambling polynomial. Therefore, the scrambling may be performed using the LFSR 211B1 that determines a sequence of outputs. The LFSR 211B1 may include a reconfigurable and tunable polynomial. The polynomial can then be tuned to determine its features, such as the number of samples before a repeated LFSR code appears. The feature may be useful in ultrasound imaging due to its repeated, periodic nature. That is, a fixed LFSR polynomial periodicity may overlap with the ultrasound periodicity, causing excess spectral content and potentially increasing the bit error rate of the system, so that providing a reconfigurable configuration provides users an ability to reconfigure the scrambler 211B to change the polynomial periodicity of the LFSR 211B1.

FIG. 2B illustrates a timing relationship for data encoding without overhead, in accordance with a representative embodiment.

In FIG. 2B, the top line shows a trigger signal from the FPGA to the transducer. For example, the trigger signal may be provided from the processing system 120C to the transducer in FIG. 1C or from the processing system 120D to the transducer in FIG. 1D. The second line shows the search for the alignment code of 00111100. The second line starts with an idle code of 01010101 until the alignment code of 00111100. After the alignment code, the second line represents transmission of data. The third line shows the flow of the DC-balanced idle code (i.e., 01010101), the alignment code (i.e., 00111100), and then the substantive formatted digital data starting with byte 0, byte 1 etc. The fourth line shows the idle select signal I from the gating logic 111C4 to the signal multiplexer 111C3 in FIG. 1C and from the gating logic 111D4 to the signal multiplexer 111D3 in FIG. 1D. The fifth line shows the align select signal A from the gating logic 111C4 to the signal multiplexer 111C3 in FIG. 1C and from the gating logic 111D4 to the signal multiplexer 111D3 in FIG. 1D.

As shown in FIG. 2B, a trigger signal indicates the start of an acoustic line. The trigger signal may be sent from a FPGA of the processing system 120C in FIG. 1C or the processing system 120D in FIG. 1D across a transducer cable to a transducer without encountering processing delay to allow for transmission of acoustic energy into the body and first echo to be reflected back. The trigger signal may set a SR flip-flop that enables a multiplexor to select an idle code (e.g., a byte comprising 01010101) to send a high-speed link back to the FPGA. The idle code may be any code that is different from the alignment code and that is DC balanced. A multiplexor may select an alignment code (e.g., a byte comprising 00111100) to tag the beginning of the data stream. Other alignment codes may be used. A serializer may form a serial data stream that is sent down the transducer cable back to the FPGA using a current mode logic buffer. As described herein, data is scrambled using a LSFR scrambler to maintain DC balance. The output of the scrambler may be used to selectively invert data bits using an XOR gate.

A current mode logic receiver in the FPGA may feed both an alignment detector set to look for the alignment code and a de-serializer to produce an 8 bit parallel data stream. The alignment detection may be gated using the enable input so that the FPGA looks for the alignment code only prior to the first data byte of the payload so that a valid data value of 00111100 does not cause an alignment code detection event. This gating of the alignment detection allows the encoding not to require extra bits. An SR flip flop may enable the alignment detection starting at the line trigger and may disable the alignment detection when the first alignment code is detected just before the first valid data of the payload. In the interval prior to the alignment detection, the transducer may send idle codes that cannot trigger an alignment detection. A LFSR scrambler and companion XOR gate of identical design as in the transducer may de-scramble the data to produce a valid data output stream.

The timing diagram of FIG. 2 shows an overall shorter sequence due to 8 bit encoding versus 10 bit encoding, resulting in 20% less power to transmit the same amount of data. The “alignment detect gate interval” is the output of the SR flip flop. The data stream shows the idle code, the alignment code as well as 8 bit data serialized/scrambled data.

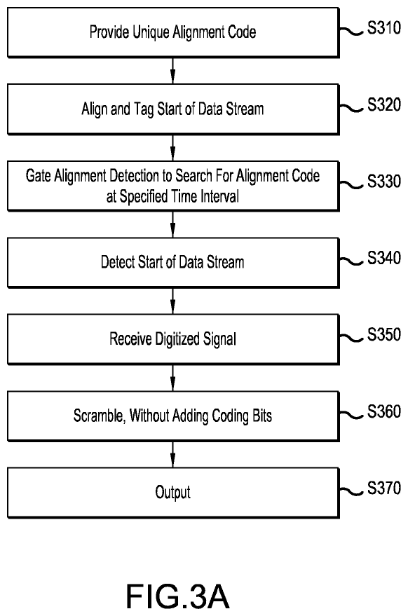

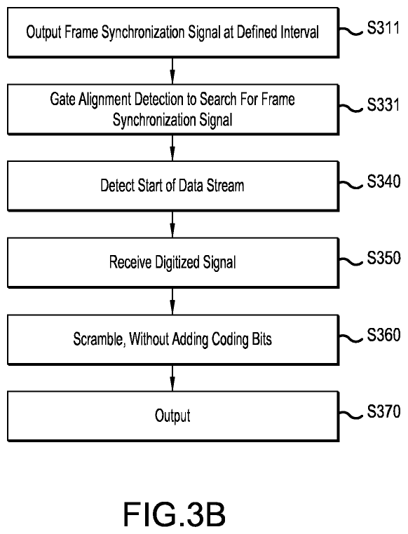

FIG. 3A illustrates a method for data encoding without overhead, in accordance with a representative embodiment.

The method of FIG. 3A starts at S310 with providing a unique alignment code. The unique alignment code may be a default alignment code set at the time a digital interface is provided from a manufacturer or intermediary, or may be set by a user. As an arbitrary example, a default byte may be set to a value of 99, i.e., 01100011, and used to tag the start of a data stream. The alignment code may be a code not otherwise used as any value in formatted digital data in a digitized signal from the data stream. The alignment code may also be recognized by both the scrambler at the coding end and the descrambler at the decoding end.

At S320, the start of a data stream is aligned and tagged with the unique alignment code. For example, the first byte or the first two bytes of a data stream may be populated with the unique alignment code.

At S330, the method of FIG. 3A includes gating an alignment detection on a receiver to search for an alignment code at a specified time interval. That is, the receiver with the descrambler is gated to perform alignment detection by searching for the alignment code at a specified time interval.

At S340, the start of the data stream is detected at the digital interface. The start of the data stream is detected when the unique alignment code is recognized in a digitized signal comprising formatted digital data.

At S350, the digitized signal is received. The digitized signal may include the unique alignment code, payload data including the formatted digital data, and an end code to mark the end of data.

At S360, the digitized signal is scrambled without adding coding bits. Scrambling may be performed using a linear feedback shift register which includes a defined polynomial fixed at reset. The scrambling is performed to reduce spectral bandwidth and enhance balance between amounts of digit values of the digital data. That is, scrambling to randomize bits results in a relatively even distribution of 0s and 1s in the scrambled digital signal.

At S370, the scrambled digital data is output, so that the method of FIG. 3A ends with outputting the scrambled digital data.

FIG. 3B illustrates another method for data encoding without overhead, in accordance with a representative embodiment.

The method of FIG. 3B starts at S311 with outputting a frame synchronization signal at a defined interval. The frame synchronization signal is used to synchronize a transmitter and receiver, and is otherwise analogous to the alignment code used in FIG. 3A.

At S331, the method of FIG. 3B include gating alignment detection on a receiver to search for the frame synchronization signal at a specific time interval.

At S340, the start of the data stream is detected at the digital interface.

At S350, the digitized signal is received. The digitized signal includes the formatted digital data.

At S360, the digitized signal is scrambled without adding coding bits to the formatted digital data. The digitized signal is scrambled in FIG. 3B to again reduce spectral bandwidth and enhance balance between amounts of digit values of the digital data.

At S370, the scrambled digital data is output, so that the method of FIG. 3B ends with outputting the scrambled digital data.

FIG. 4 illustrates an example circuit of a scrambler for data encoding without overhead in a reconfigurable manner, in accordance with a representative embodiment.

In FIG. 4, the LFSR includes the first multiplexer 511, the first XOR element 512, the first logic element 513a, the second logic element 513b, the second XOR element 514 and the second multiplexor 516. The circuit in FIG. 4 also includes the frame Sync memory 515.

The LFSR feeds back its 32 bits of parallel output labelled as “LFSR<31:0>” and uses a polynomial address to multiplex the 32 bits to 2 outputs using the first multiplexer 511. The first multiplexer 511 outputs the 2 outputs to the first XOR element 512. The first XOR element 512 provides the data output D to the first logic element 513a. The first logic element 513a also receives a clock signal, a reset signal R, and 24 bits of seed data labelled as “Seed<31:8>”. The first logic element 513a outputs 24 bits labelled as “LFSR<31:8> to the second XOR element 514. The second XOR element 514 provides 24 bits of scrambled output data labelled as ×Scrambled<23:0>” from the second XOR element 514. The scrambled output data is then multiplexed by the second multiplexor 516 with a frame sync signal from the frame Sync memory 515 to produce the output signal labelled as “out”.

The first multiplexer 511 determines the feedback polynomial of the LFSR. The first XOR element 512 provides the mathematical addition in the LFSR. The first logic element 513a stores the digital value at the input “D”, outputting it to “Q”, on the rising edge of the input clock labelled “CLK”. The first logic element 513a will output a 0 when the input labelled “RESET” is raised to a digital logic high. The first logic element 513a will output a 1 when the input labelled “S” is raised to a digital logic high. The input bus labelled “Seed<31:8>” will cause the output of the first logic element 513a to output the seed value. The second logic element 513b stores the eight highest bits so that larger number polynomials can be used. The first logic element 513a and the second logic element 513b output the LFSR data stream and feed back to the inputs of the LFSR to calculate the polynomial. The second XOR element 514 scrambles the data by XORing the incoming parallel 24 bit data stream with the 24 bit output of the LFSR. The output of the second XOR element 514, “Scrambled<23:0>, represents the scrambled data. The Frame Sync Memory 515 stores a frame sync word, or a gate alignment word. The second multiplexor 516 selects between the two inputs “Scrambled<23:0>” and the 24 bit output of Frame Sync Memory 515. During frame synchronization, the second multiplexor 516 selects the input from Frame Sync Memory 515 to be output to “Out.” Outside of frame synchronization, the second multiplexor 516 selects the input “Scrambled<23:0>”.

In FIG. 4, an LFSR is used to scramble digital ultrasound data to reduce the bandwidth of the signals before transmitting the signals elsewhere. Coding bits are not added, and this results in saved power. The periodic nature of data such as digital ultrasound data is relied-on to avoid needing the coding bits to guarantee run lengths. The scrambling LFSR in FIG. 4 may be implemented as a module in a digital transducer probe;. A descrambling LFSR may be added into receiving hardware.

In FIG. 4, the scrambler is parallel and synchronous, and uses a reconfigurable and tunable polynomial. The seed for the scrambler in FIG. 4 may be fixed or may be reconfigurable. All four of these characteristics are variable according to the teachings herein. Each of the four characteristics is explained further in the following paragraphs.

The LFSR may be fixed polynomial LFSR or may be a reconfigurable polynomial LFSR. The LFSR polynomial determines the sequence of outputs. A fixed polynomial LFSR will follow a defined polynomial upon reset. A reconfigurable polynomial LFSR allows the user to dictate the polynomial used and can be reconfigured when desired. The LFSR in FIG. 4 is a reconfigurable polynomial LFSR.

The LFSR may use a fixed seed code or may use a reconfigurable seed code. The LFSR seed code determines the first output pattern the LFSR uses. A fixed seed code will reset the LFSR to a specific start code. A reconfigurable seed allows the user to dictate the specific start code and can be reconfigured when desired. The seed code in FIG. 4 is reconfigurable.

The LFSR may provide a serial output or a parallel output. The output mode of an LFSR determines how many bits are scrambled at once. A serial output will scramble one bit at a time at a rate equal to the data rate of the system. A parallel output will scramble N bits at a time at 1/Nth the data rate of the system. Serial scramblers are smaller than parallel scramblers, while parallel scramblers use less power than serial ones. The LFSR in FIG. 4 provides output in parallel.

The LFSR may perform synchronous scrambling or may be perform self-synchronous scrambling. A synchronous scrambler requires a frame synchronization header to synchronize the seed code in the scrambler and descrambler. A self-synchronous scrambler uses the data itself as a seed and requires only the polynomial to descrambler without a frame synchronization. The system in FIG. 4 is a synchronous scrambler.

An implementation of a scrambler capable of using any 24-bit polynomial for the LFSR is seen in FIG. 2. In order to synchronize the LFSR with the receiving hardware, a Frame Sync header word is multiplexed into the data stream immediately after an acoustic line is triggered. The receiving hardware, such as an FPGA, is programmed to align the decoding scrambler with the repeated Frame Sync words.

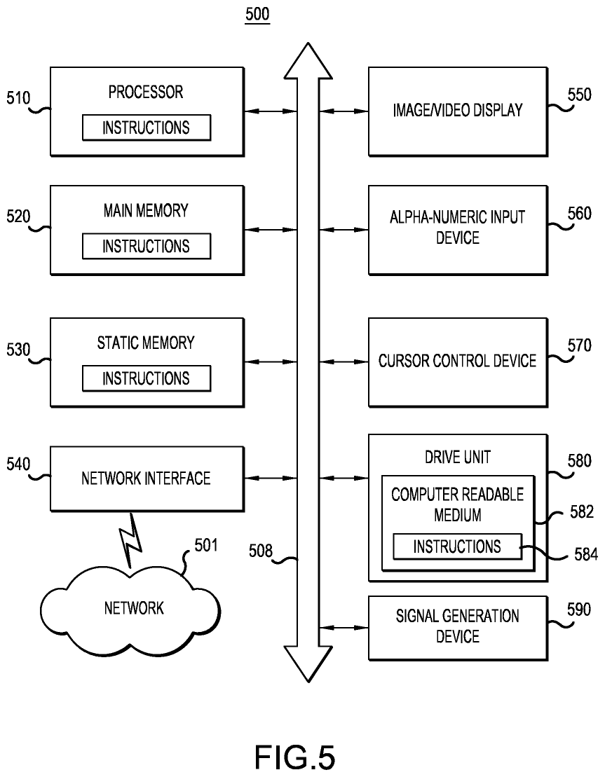

FIG. 5 illustrates a computer system, on which a method for data encoding without overhead is implemented, in accordance with another representative embodiment.

Referring to FIG. 5, the computer system 500 includes a set of software instructions that can be executed to cause the computer system 500 to perform any of the methods or computer-based functions disclosed herein. The computer system 500 may operate as a standalone device or may be connected, for example, using a network 501, to other computer systems or peripheral devices. In embodiments, a computer system 500 performs logical processing based on digital signals received via an analog-to-digital converter.

In a networked deployment, the computer system 500 operates in the capacity of a server or as a client user computer in a server-client user network environment, or as a peer computer system in a peer-to-peer (or distributed) network environment. The computer system 500 can 17 also be implemented as or incorporated into various devices, such as a workstation that includes a controller, a stationary computer, a mobile computer, a personal computer (PC), a laptop computer, a tablet computer, or any other machine capable of executing a set of software instructions (sequential or otherwise) that specify actions to be taken by that machine. The computer system 500 can be incorporated as or in a device that in turn is in an integrated system that includes additional devices. In an embodiment, the computer system 500 can be implemented using electronic devices that provide voice, video or data communication. Further, while the computer system 500 is illustrated in the singular, the term “system” shall also be taken to include any collection of systems or sub-systems that individually or jointly execute a set, or multiple sets, of software instructions to perform one or more computer functions.

As illustrated in FIG. 5, the computer system 500 includes a processor 510. The processor 510 may be considered a representative example of a processor of a controller and executes instructions to implement some or all aspects of methods and processes described herein. The processor 510 is tangible and non-transitory. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor 510 is an article of manufacture and/or a machine component. The processor 510 is configured to execute software instructions to perform functions as described in the various embodiments herein. The processor 510 may be a general-purpose processor or may be part of an application specific integrated circuit (ASIC). The processor 510 may also be a microprocessor, a microcomputer, a processor chip, a controller, a microcontroller, a digital signal processor (DSP), a state machine, or a programmable logic device. The processor 510 may also be a logical circuit, including a programmable gate array (PGA), such as a field programmable gate array (FPGA), or another type of circuit that includes discrete gate and/or transistor logic. The processor 510 may be a central processing unit (CPU), a graphics processing unit (GPU), or both. Additionally, any processor described herein may include multiple processors, parallel processors, or both. Multiple processors may be included in, or coupled to, a single device or multiple devices.

The term “processor” as used herein encompasses an electronic component able to execute a program or machine executable instruction. References to a computing device comprising “a processor” should be interpreted to include more than one processor or processing core, as in a multi-core processor. A processor may also refer to a collection of processors within a single computer system or distributed among multiple computer systems. The term computing device should also be interpreted to include a collection or network of computing devices each including a processor or processors. Programs have software instructions performed by one or multiple processors that may be within the same computing device or which may be distributed across multiple computing devices.

The computer system 500 further includes a main memory 520 and a static memory 530, where memories in the computer system 500 communicate with each other and the processor 510 via a bus 508. Either or both of the main memory 520 and the static memory 530 may be considered representative examples of a memory of a controller, and store instructions used to implement some or all aspects of methods and processes described herein. Memories described herein are tangible storage mediums for storing data and executable software instructions and are non-transitory during the time software instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The main memory 520 and the static memory 530 are articles of manufacture and/or machine components. The main memory 520 and the static memory 530 are computer-readable mediums from which data and executable software instructions can be read by a computer (e.g., the processor 510). Each of the main memory 520 and the static memory 530 may be implemented as one or more of random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. The memories may be volatile or non-volatile, secure and/or encrypted, unsecure and/or unencrypted.

“Memory” is an example of a computer-readable storage medium. Computer memory is any memory which is directly accessible to a processor. Examples of computer memory include, but are not limited to RAM memory, registers, and register files. References to “computer memory” or “memory” should be interpreted as possibly being multiple memories. The memory may for instance be multiple memories within the same computer system. The memory may also be multiple memories distributed amongst multiple computer systems or computing devices.

As shown, the computer system 500 further includes a video display unit 550, such as a liquid crystal display (LCD), an organic light emitting diode (OLED), a flat panel display, a solid-state display, or a cathode ray tube (CRT), for example. Additionally, the computer system 500 includes an input device 560, such as a keyboard/virtual keyboard or touch-sensitive input screen or speech input with speech recognition, and a cursor control device 570, such as a mouse or touch-sensitive input screen or pad. The computer system 500 also optionally includes a disk drive unit 580, a signal generation device 590, such as a speaker or remote control, and/or a digital interface 540 that interfaces the computer system 500 with a network.

In an embodiment, as depicted in FIG. 5, the disk drive unit 580 includes a computer-readable medium 582 in which one or more sets of software instructions 584 (software) are embedded. The sets of software instructions 584 are read from the computer-readable medium 582 to be executed by the processor 510. Further, the software instructions 584, when executed by the processor 510, perform one or more steps of the methods and processes as described herein. In an embodiment, the software instructions 584 reside all or in part within the main memory 520, the static memory 530 and/or the processor 510 during execution by the computer system 500. Further, the computer-readable medium 582 may include software instructions 584 or receive and execute software instructions 584 responsive to a propagated signal, so that a device connected to a network 501 communicates voice, video or data over the network 501. The software instructions 584 may be transmitted or received over the network 501 via the digital interface 540.

In an embodiment, dedicated hardware implementations, such as application-specific integrated circuits (ASICs), field programmable gate arrays (FPGAs), programmable logic arrays and other hardware components, are constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing may implement one or more of the methods or functionalities as described herein, and a processor described herein may be used to support a virtual processing environment.

Accordingly, data encoding without overhead enables lower power digital communication.

Although data encoding without overhead has been described with reference to several exemplary embodiments, it is understood that the words that have been used are words of description and illustration, rather than words of limitation. Changes may be made within the purview of the appended claims, as presently stated and as amended, without departing from the scope and spirit of data encoding without overhead in its aspects. Although data encoding without overhead has been described with reference to particular means, materials and embodiments, data encoding without overhead is not intended to be limited to the particulars disclosed; rather data encoding without overhead extends to all functionally equivalent structures, methods, and uses such as are within the scope of the appended claims.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A method of encoding data for transmission, the method comprising:
aligning and tagging a start of a data stream;
receiving at a communication interface comprising a scrambler, a digitized signal comprising formatted digital data;
scrambling the formatted digital data into scrambled digital data to reduce spectral bandwidth and enhance balance between amounts of digit values of the digital data and without adding coding bits to the formatted digital data; and
outputting the scrambled digital data.

2. The method of claim 1, further comprising gating an alignment detection on a receiver to search for an alignment code at a specific time interval.

3. The method of claim 1, further comprising providing a unique alignment code at the start of the data stream to align the formatted digital data.

4. The method of claim 1, wherein the formatted digital data comprises an ultrasound signal.

5. The method of claim 1, wherein the scrambling is based on statistical properties to meet run length requirements.

6. The method of claim 1, wherein the scrambling is performed using a linear feedback shift register that determines a sequence of outputs and including a defined polynomial fixed at reset.

7. The method of claim 1, wherein the scrambling is performed using a linear feedback shift register that determines a sequence of outputs and including a reconfigurable and tunable polynomial.

8. The method of claim 7, wherein the method is performed by a module in a digital transducer probe, and the module includes the linear feedback shift register.

9. The method of claim 1, wherein the scrambling is performed using a linear feedback shift register that uses a fixed seed code to determine a first output pattern used by the linear feedback shift register.

10. The method of claim 1, wherein the scrambling is performed using a linear feedback shift register that uses a reconfigurable seed code to determine a first output pattern used by the linear feedback shift register.

11. The method of claim 1, wherein the scrambling is performed using a linear feedback shift register that linearly scrambles bits one at a time.

12. The method of claim 1, wherein the scrambling is performed using a linear feedback shift register that scrambles a plurality of bits in parallel.

13. The method of claim 1, further comprising:
outputting a frame synchronization signal at a defined interval to synchronize a seed code and achieve bit alignment.

14. The method of claim 1, wherein the scrambling and outputting are performed without transmitting a frame synchronization signal such that descrambling is performed using the scrambled digital data as a seed code.

15. A digital interface, comprising:
a receiver that receives a digitized signal comprising formatted digital data, the receiver comprising a receive logic device adapted to detect an alignment code and align with respect to this code;
a scrambler that scrambles the formatted digital data into scrambled digital data to reduce spectral bandwidth and enhance balance between amounts of digit values of the digital data and without adding coding bits to the formatted digital data; and
an output that outputs the scrambled digital data.

16. The digital interface of claim 15, wherein the receiver is configured to gate an alignment detection to search for an alignment code at a specific time interval.

17. The digital interface of claim 15, wherein a unique alignment code is provided at a start of a data stream to align the formatted digital data.

18. The digital interface of claim 15, wherein the digital interface is included in a digital transducer probe in an ultrasound system and the formatted digital data comprises an ultrasound signal.

19. The digital interface of claim 15, wherein the scrambler comprises:
a linear feedback shift register that determines a sequence of outputs and including a reconfigurable and tunable polynomial.

20. The digital interface of claim 15, wherein the scrambler comprises:
a linear feedback shift register that uses a reconfigurable seed code to determine a first output pattern used by the linear feedback shift register.

21. The digital interface of claim 15, wherein the scrambler comprises:
a linear feedback shift register that scrambles a plurality of bits in parallel.

22. The digital interface of claim 15, further comprising:
a frame synchronization circuit that provides a frame synchronization signal at a defined interval to synchronize a seed code and achieve bit alignment.
